(19) United States
(12) Patent Application Publication
(10) Pub. No.: US 2013/0005231 A1
(43) Pub. Date: Jan. 3, 2013

(54) INCOMING AIR SUPPLY SYSTEM FOR PASSENGERS IN AIRCRAFT

(75) Inventors: Uwe Schneider, Jork (DE); Dorothee Lang, Pinneberg (DE); Sebastian Umlauft, Hamburg (DE); Jorinde Wittkugel, Bad Fallingbostel (DE); Patrick Rollfink, Hamburg (DE)

(73) Assignee: AIRBUS OPERATIONS GMBH, Hamburg (DE)

(21) Appl. No.: 13/586,251

(22) Filed: Aug. 15, 2012

Related U.S. Application Data
(63) Continuation of application No. PCT/EP2011/051057, filed on Jan. 26, 2011.
(60) Provisional application No. 61/306,198, filed on Feb. 19, 2010.

(30) Foreign Application Priority Data
Feb. 19, 2010 (DE) 10 2010 008 626.6

(51) Int. Cl. B64D 13/00

(52) U.S. Cl. 454/76

(57) ABSTRACT

Incoming air system for passengers in a passenger compartment, in which the supply duct does not have to be reconstructed if the seat configuration is altered. This is provided by means of an air distribution element, which is continuous in the longitudinal direction of the aircraft and which comprises openings at defined positions which are adapted to possible seat layouts. Openings which are not required are sealed, for example by means of a selection element which encloses the air distribution element and is slitted on one side.

### CROSS-REFERENCE TO RELATED APPLICATIONS

The present application is a continuation of International Application No. PCT/EP2011/051057, filed Jan. 26, 2011, published in German, which claims the priority of the U.S. Provisional Patent Application No. 61/306,198, filed Feb. 19, 2010, and of German Patent Application No. 10 2010 008 626.6 filed Feb. 19, 2010, the disclosures of which are herein incorporated by reference.

### FIELD OF THE INVENTION

The invention relates to an incoming air system for passengers in a passenger compartment of for example an aircraft. In particular, the invention relates to a system for distributing incoming air for individually supplying passengers.

### BACKGROUND OF THE INVENTION

A system is known from DE 10 2008 026 093 A1 for ventilating an aircraft cabin comprising an air delivery pipe, which is connected to an air source, and a plurality of air distribution lines, which branch off from the air delivery pipe. This system is adapted for delivering at least part of the air in the aircraft cabin to air outlets which are arranged in a distributed manner.

DE 10 2007 014 406 B3 discloses a supply duct comprising an air distribution system and having an elongate housing, a hollow profile which extends in the longitudinal direction of the housing, and at least one air shower comprising an air inlet and at least one air outlet. A plurality of perforation openings are formed in a generated surface of the hollow profile. The air shower is configured in such a way that it lies tightly against the generated surface of the hollow profile in a region of the air inlet. Perforation openings which discharge in an air inlet of an air shower can be sealed off by means of an adhered adhesive film. The supply duct makes variable positioning of air showers possible along the longitudinal direction of the supply duct.

However, in air distribution systems of this type, there is the problem that the air showers have to be adapted to the respective seat positions, and this presents a major obstacle to installation when fitting and refitting the cabin. This greatly restricts the flexibility of the cabin furnishing, since the aircraft construction documents and system provisions (connection points) have to be fixed at a very early definition time.

### SUMMARY OF THE INVENTION

An aspect of the invention is to provide an incoming air system which can easily be adapted to an altered seat layout.

In general, an incoming air system for passengers according to an embodiment of the invention comprises an air distribution element and a selection element. On one side, the air distribution element comprises a row of openings, and on the other side, the selection element is of a configuration which makes it possible to lock and release this row of openings. The air distribution element and the selection element are movable relative to one another in such a way that an air current through the plurality of openings is made possible or blocked in accordance with the positioning of the air distribution element and the selection element relative to one another.

In accordance with one embodiment of the invention, the air distribution element comprises at least two rows of openings, the mutual spacing of the openings in one row being different from the mutual spacing of the openings in the other row.

Preferably, the spacing between two openings in a row is selected in such a way that it corresponds to a possible seat spacing, in such a way that, when this row of openings is released by means of the selection element, each opening is released above a row of seats, and the passengers of each individual row of seats can be supplied with air.

A second row of openings may have a spacing between the respective openings which corresponds to a different seat spacing or seat layout. In this way, in accordance with the position of the air distribution element and the selection element relative to one another, an air current through the openings of one of the rows can be made possible whilst the openings of the other rows are covered and a corresponding airflow is thus blocked.

As soon as the seat layout in a passenger compartment of for example an aircraft is altered, merely an alteration in the position of the air distribution element relative to the selection element is required so as to adapt the incoming air system to the altered seat layout.

In accordance with one embodiment of the invention, the openings of a row are arranged along a longitudinal direction of the air distribution element.

The incoming air system according to an embodiment of the invention may further comprise an air preparation unit, which can bring air, which is prepared in accordance with the specific configuration of the air distribution element or of the selection element, that is to say air having for example a desired air humidity and temperature, and which may also be filtered, into the air distribution element or the selection element.

The incoming air system according to an embodiment of the invention may further comprise a plurality of passenger supply units, which are arranged in such a way that they are each allocated to an opening of the row of openings. Conventionally, passenger supply units of this type comprise air nozzles, which can be opened and closed and of which the orientation can be changed.

When the air distribution element and the selection element are arranged relative to one another in such a way as to release the row of openings having a spacing between the respective openings which corresponds to the spacing between two rows of seats in a specific seat layout, prepared air can be delivered selectively to a respective passenger.

In accordance with one embodiment of the invention, the incoming air system is used in an aircraft to supply the passengers with individual incoming air. In this context, it should be noted that the incoming air system may also be used in any desired passenger transport means, such as in a bus, a railway carriage or a ship.

The above-described aspects and further aspects, features and advantages of the invention may also be taken from the examples of the embodiments which are described in the following with reference to the appended drawings.

### BRIEF DESCRIPTION OF THE DRAWINGS

FIG. 1 is a longitudinal sectional drawing of an aircraft passenger compartment.

FIG. 2 is a cross-sectional drawing of an aircraft passenger compartment comprising an incoming air system according to the invention above the rows of seats.

FIG. 3a shows an air distribution element in accordance with an embodiment of the invention.

FIG. 3b shows an air distribution element which is mounted in a selection element.

FIG. 4 shows an incoming air system in accordance with a further embodiment of the invention.

FIG. 5 shows an incoming air system in accordance with another further embodiment of the invention.

FIG. 6 is a schematic drawing of an air distribution element according to the invention.

FIG. 7 shows an incoming air system in accordance with a further embodiment of the invention.

FIG. 8 shows an incoming air system according to the invention comprising a transition profile.

FIG. 9 shows an incoming air system according to the invention comprising a plurality of passenger supply units.

FIG. 10 shows an incoming air system according to the invention comprising a displaceable passenger supply unit.

### DETAILED DESCRIPTION OF THE EMBODIMENTS

An incoming air system according to the invention comprises a duct, which is continuous in the longitudinal direction, for supplying the passengers with incoming air, comprising openings or outlets of which the position can be changed. As a result, the passengers are supplied with introduced air in every possible seat arrangement, without the device having to be restructured. The duct may be in the form of an endless profile, or else may be pre-mounted on the hatrack. No infill panels, and thus no new parts for refitting, are required.

A plurality of rows of openings may be provided, each having different spacings between the individual openings. Openings which are not required are locked, for example by means of a further pipe which encloses the air line. By means of a slit in the further pipe, a particular row of openings can be selectively left open. By rotating the air line, for example in a pneumatically controlled manner, it is possible to switch from a row comprising openings at a first spacing to another row comprising openings at a different spacing. Only particular openings are released, which connect to fixed or displaceably adjustable air nozzles or to preset simple air outlets.

As a result of the limited number of possible seat spacings, there are at most two air outlets per hat rack which are required. Thus, with a spacing of the air outlets of approximately 8 inches (20.32 cm), any seat configuration can be supplied. The required air outlets can be controlled individually by means of the air line having circumferential holes and covering, as is illustrated and described in the following.

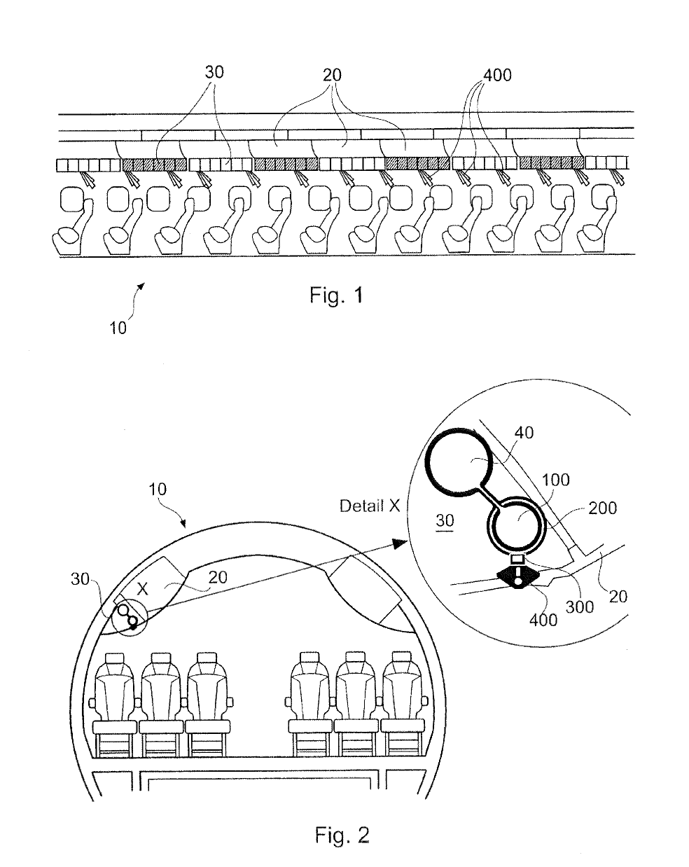

FIG. 1 is a longitudinal section through a passenger compartment of an aircraft. A plurality of rows of seats are arranged in the passenger compartment 10. Hat racks or luggage compartments 20, as well as passenger supply units 30 for supplying the passengers with signals, information, electrical or electronic terminals and fresh air, are located above the rows of seats. As is shown in FIG. 1, air nozzles 400 which are allocated to each individual row of seats are provided, and are arranged on the passenger supply duct 30 at a corresponding mutual spacing.

FIG. 2 is a cross-section through a passenger compartment of an aircraft. In the passenger compartment 10, luggage compartments 20 and passenger supply ducts 30 are shown above the seats. Inside the passenger supply duct 30, an example incoming air system according to the invention is shown (in particular in Detail X). The incoming air system comprises an air preparation unit 40, an air distribution element 100, a selection element 200, a transition profile 300 and an air nozzle 400 which is inserted into a lining part 20.

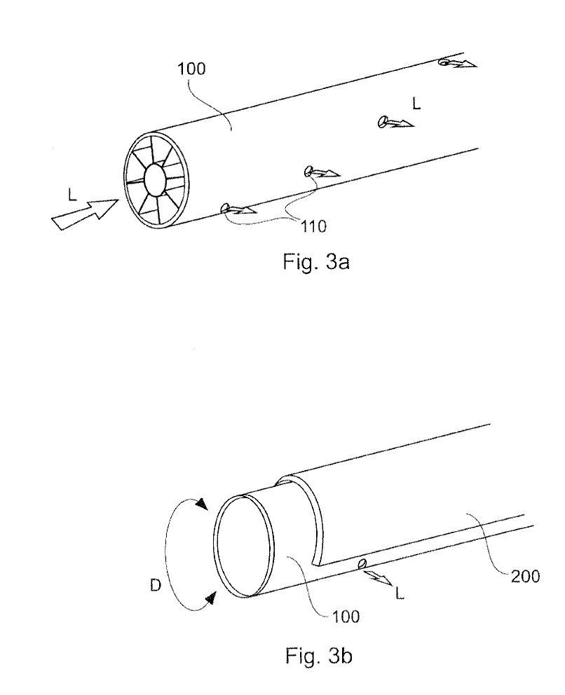

FIG. 3a shows an air distribution element 100 of an incoming air system according to the invention, the air distribution element being formed as a pipe and comprising a honeycombed internal structure, through which air can be passed to the openings 110 in the outer wall of the pipe.

FIG. 3b shows an incoming air system according to the invention, the air distribution element 100 being configured as a pipe and the selection element comprising a slit, which corresponds to a row of openings in such a way that only a particular row of openings is released by the slit in the selection element. The air distribution element is arranged movably in the selection element, in such a way that by rotating the air distribution element 100 in the direction of the arrow D, a desired row of openings 110 can be orientated relative to the slit in the selection element 200.

In accordance with this embodiment, air is blown in the direction of the arrow L into an end face of the air distribution element 100. This air only exits the air distribution element 100 through the openings 110 which are not covered by the selection element 200.

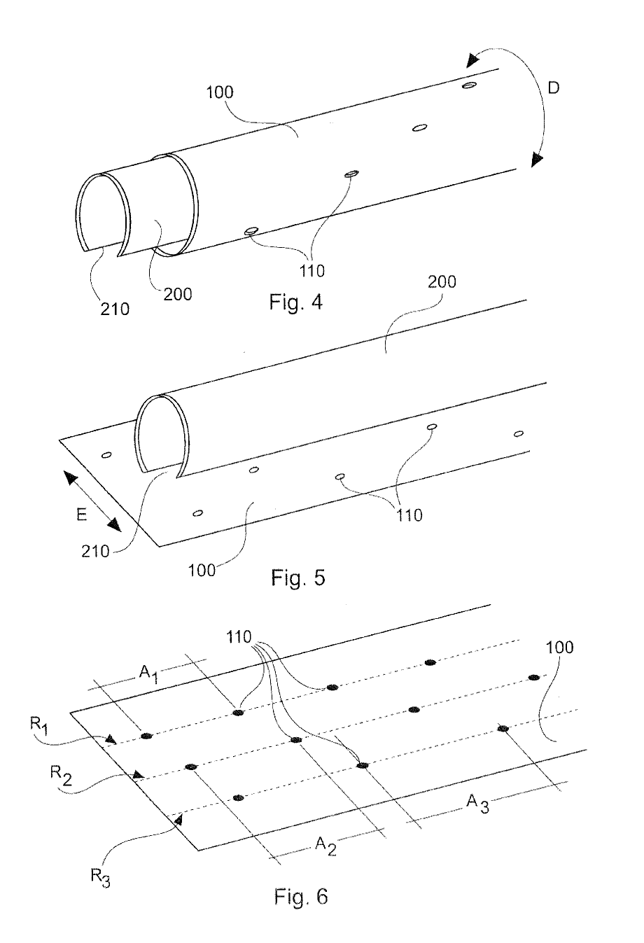

FIG. 4 shows an incoming air system according to the invention, the air distribution element 100 being formed as a pipe and the selection element also comprising a slit which corresponds to a row of openings, the air distribution element 100 being arranged movably about the selection element 200 in this case.

In accordance with this embodiment, air is blown into the selection element 200 at an end face thereof, this air only being able to escape through the slit in the selection element 200 again at the points at which an opening 110 of the air distribution element 100 is also arranged.

FIG. 5 shows an incoming air system of a further embodiment according to the invention, the air distribution element being formed as a plate and the selection element also comprising a slit. The air distribution element 100 is arranged movably in front of the slit 210 of the selection element 200. In this case too, air is blown into the selection element 200, but this air can only escape from the slit in places where openings 110 of the air distribution element 100 are also arranged. By displacing the air distribution element 100 in the direction of the arrow E, transverse to the longitudinal direction of the selection element 200, it is possible to switch between a plurality of rows of openings.

FIG. 6 is a schematic drawing of an air distribution element 100 comprising a plurality of rows R1, R2 and R3 of openings 110. In this exemplary drawing, the openings 110 of the row R1 are arranged at a mutual spacing A1 in each case. The openings 110 of the row R2 are arranged at a mutual spacing A2. The openings 110 of the row R3 are arranged at a mutual spacing A3. In this example, the spacing A1 is smaller than the spacing A2, which in turn is smaller than the spacing A3. The drawing of FIG. 6 is particularly adapted for illustrating the arrangement of a plurality of rows of openings in an air distribution element 100.

An arrangement of this type of openings 110 could for example be formed in a plate in an air distribution element in accordance with the embodiment which is shown in FIG. 5.

If a generated surface of a pipe is formed from the arrangement of rows of openings which is shown in a plane in FIG. 6, an air distribution element, such as is shown for example in FIGS. 3 and 4, can be provided.

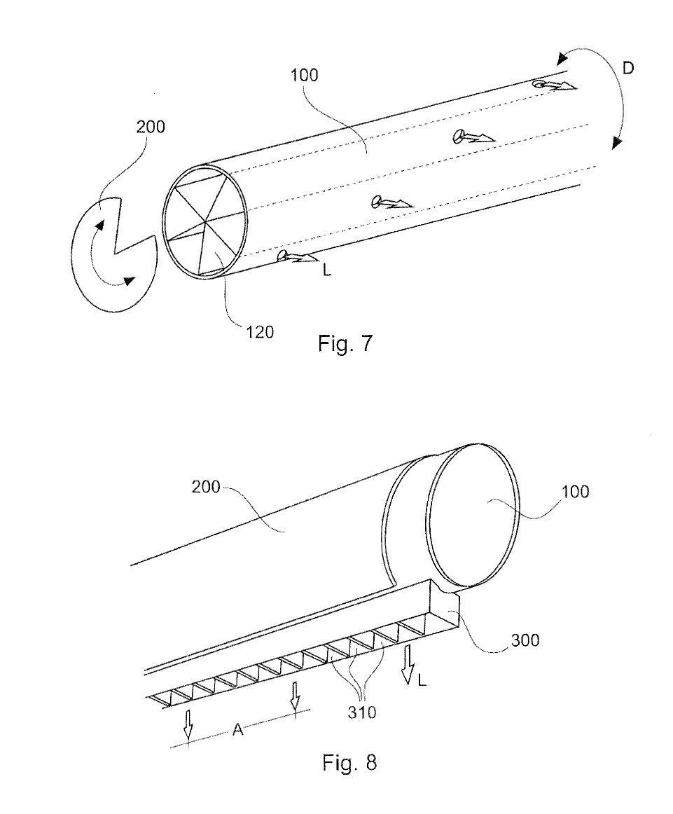

FIG. 7 shows a further embodiment in accordance with the invention, the air distribution element 100 being formed as a strand-cast profile comprising a plurality of chambers which are formed in the longitudinal direction. A row of openings is provided in the outer wall of a particular chamber. In accordance with this embodiment, the selection element 200 is arranged at the air inlet of the air distribution element 100 and is adapted for passing the airflow into a particular chamber and to cover up the other chambers. In this way, it can be made possible for air to exit through openings in the outer wall of a particular chamber. By rotating the air distribution element 100 in the direction of the arrow D relative to the selection element 200, the airflow can be provided by way of a different chamber, which is equipped with a row of holes which are arranged at a larger or smaller relative spacing.

It is noted that other variants of the embodiments which are shown by way of example in FIGS. 3, 4, 5, 7 can be understood and carried out by a person skilled in the art when implementing the claimed invention.

FIG. 8 shows an air distribution element 100 and a selection element 200. At the position of the slit in the selection element 200, an elongate profile element 300 is shown, which consists of a row of air apertures 310. The profile element 300 may be configured in such a way that the air apertures 310 are arranged at a minimum mutual spacing, in such a way that an air aperture 310 is formed in a manner corresponding to all of the openings 110 in the air distribution element 100. As is shown in FIG. 8, in a particular combination, air L only exits in individual air apertures at the mutual spacing A.

Depending on the available space within the passenger supply duct 30, it may be advantageous to provide a profile element 300 between the air distribution element and selection element and an air nozzle.

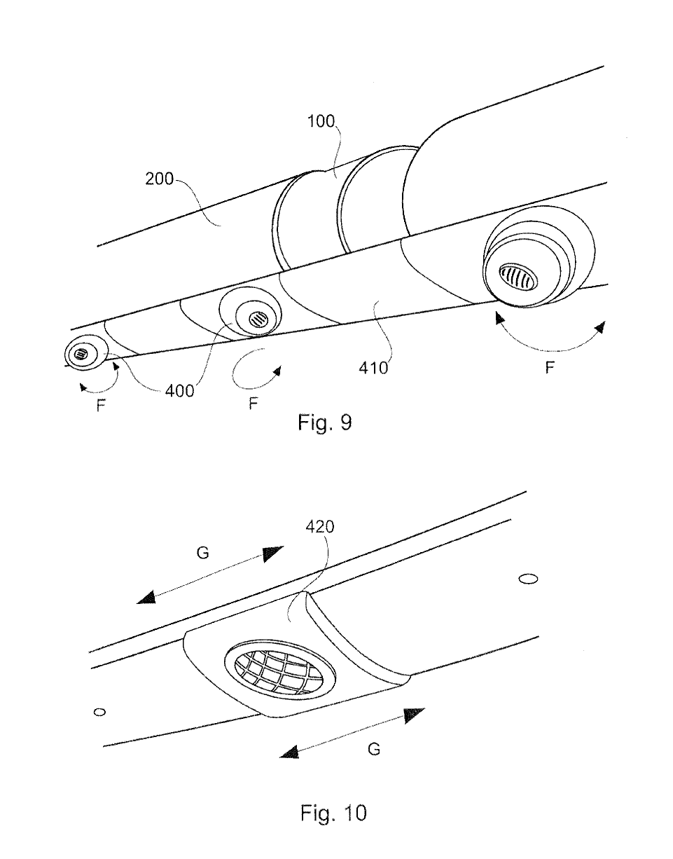

As is shown in FIG. 9, air nozzles 400 for example may be provided, so as to make it possible to control the air from the openings of the air distribution element 100 in a manner which is comfortable for a passenger. The air nozzles 400 in FIG. 9 are ball elements, which can be pivoted and rotated in the directions of the arrows F so as to set a desired outflow direction for the air.

Panels 410 are provided between the air nozzles 400 as lining elements.

FIG. 10 shows an air nozzle 420 in accordance with another embodiment. This air nozzle 420 is distinguished by the fact that it is formed so as to be displaceable along the air distribution element in the direction of the arrow G. If the seat layout is restructured, the position of the air nozzle can be adapted by simple displacement thereof, by means of an air nozzle 420 corresponding to the position of the openings of another row having a greater spacing between the respective openings.

Although the invention has been illustrated and described in detail in the drawings and the above description, it is noted that illustrations and descriptions of this type are merely illustrative or exemplary and not restrictive, in such a way that the invention is not limited by the disclosed embodiments. In the claims, the word “comprising” does not exclude the possibility of other elements and the indefinite article “a” does not exclude the possibility of a plurality.

The fact that particular features may be mentioned in different dependent claims does not, in itself, limit the subject-matter of the invention. Combinations of these features may also advantageously be used. The reference numerals in the claims are not intended to limit the scope of the claims.

### LIST OF REFERENCE NUMERALS

10 passenger compartment
20 hat rack
30 passenger supply duct
40 air preparation unit
100 air distribution unit
110 openings
120 duct
200 selection element
210 slit
300 profile element
310 air aperture
400 air nozzle
410 panel
420 displaceable air nozzle
R1, R2, R3 row
A1, A2, A3 spacing between openings of one row
D, E, F, G movement directions
L airflow

1-10. (canceled)

11. An air system for passengers, comprising:
an air distribution element; and
a selection element,
wherein the air distribution element comprises at least first and second rows of openings, the openings being arranged at regular mutual spacings, wherein the spacing of the openings in the first row is different from the spacing of the openings in the second row,
wherein the air distribution element and the selection element are movable relative to one another in such a way that an air current through the plurality of openings is made possible or blocked in accordance with the positioning of the air distribution element and the selection element, and
wherein an air current through the openings of one of the first and second rows or through the openings of another one of the first and second rows is made possible in accordance with the positioning of the air distribution element and the selection element relative to one another.

12. The air system according to claim 11, wherein the openings are arranged along a longitudinal direction of the air distribution element.

13. The air system according to claim 11, wherein the air distribution system comprises a pipe, wherein the selection element has a slit corresponding to at least one of the first and second rows of openings, and wherein the air distribution element is arranged movably in the selection element.

14. The air system according to claim 11, wherein the air distribution element comprises a pipe, wherein the selection element comprises a slit corresponding to at least one of the rows of openings, and wherein the air distribution element is arranged movably about the selection element.

15. The air system according to claim 11, wherein the air distribution element comprises a plate, wherein the selection element comprises a slit corresponding to at least one of the rows of openings, and wherein the air distribution element is arranged movably in front of the slit of the selection element.

16. The air system according to claim 11, wherein the air distribution element comprises a strand-cast profile comprising a plurality of chambers formed in the longitudinal direction, wherein the rows of openings are provided in the outer wall of one of the plurality of chambers, and wherein the selection element is adapted for making possible or blocking the airflow into this chamber.

17. The air system according to claim 11, further comprising an air preparation unit.

18. The air system according to claim 11, further comprising a plurality of passenger supply units arranged in such a way that each one of the plurality of passenger supply units is allocated to an opening of the rows of openings.

19. An aircraft comprising an incoming air system for supplying the passengers with individual incoming air, the air system comprising:
an air distribution element; and
a selection element;
wherein the air distribution element comprises at least first and second rows of openings, the openings being arranged at regular mutual spacings, wherein the spacing of the openings in the first row is different from the spacing of the openings in the second row,
wherein the air distribution element and the selection element are movable relative to one another in such a way that an air current through the plurality of openings is made possible or blocked in accordance with the positioning of the air distribution element and the selection element, and
wherein an air current through the openings of one of the first and second rows or through the openings of another one of the first and second rows is made possible in accordance with the positioning of the air distribution element and the selection element relative to one another.
